(19) United States
(12) Patent Application Publication
(10) Pub. No.: US 2022/0156513 A1
(43) Pub. Date: May 19, 2022

(54) METHOD AND SYSTEM FOR LOCALIZING AN ANOMALY IN AN IMAGE TO BE DETECTED, AND METHOD FOR TRAINING RECONSTRUCTION MODEL THEREOF

(71) Applicant: Electronics and Telecommunications Research Institute, Daejeon (KR)

(72) Inventors: Hyun Yong LEE, Gwangju (KR); Nack Woo KIM, Gwangju (KR); Sang Jun PARK, Gwangju (KR); Byung Tak LEE, Suwon-si (KR); Jun Gi LEE, Gwangju (KR)

(73) Assignee: Electronics and Telecommunications Research Institute, Daejeon (KR)

(21) Appl. No.: 17/190,597

(22) Filed: Mar. 3, 2021

(30) Foreign Application Priority Data
Nov. 16, 2020 (KR) 10-2020-0152885

(51) Int. Cl. G06K 9/62; G06T 7/11; G06T 5/50

(52) U.S. Cl. CPC G06K 9/6256; G06T 7/11; G06T 2207/20081; G06K 9/6262; G06T 5/50

(57) ABSTRACT

Provided is a method of localizing an anomaly in a target image. The method includes training a reconstruction model using a normal image, deriving a reconstructed image by applying a target image, which is subject to detection, to the trained reconstruction model, generating an anomaly map on the basis of a result of comparing the reconstructed image and the target image, and localizing an anomaly through the generated anomaly map.

### CROSS-REFERENCE TO RELATED APPLICATION

This application claims priority to and the benefit of Korean Patent Application No. 10-2020-0152885, filed on Nov. 16, 2020, the disclosure of which is incorporated herein by reference in its entirety.

### BACKGROUND

### 1. Field of the Invention

The present invention relates to a method and system for localizing an anomaly in a target image and a method of training a reconstruction model thereof.

### 2. Discussion of Related Art

A function of determining whether an abnormal pattern is included in a given image (anomaly detection) and a function of finding an abnormal pattern position that is expected to contain an abnormal pattern (anomaly localization) are required in many applications.

For example, based on an image in a manufacturing process, it is necessary to determine whether an intended process has been properly performed and also to determine the position of a process defect when the defect occurs.

In the related art, not only a normal image but also an abnormal image that is difficult to obtain is required to train a reconstruction model for localizing an anomaly. Accordingly, when it is difficult to acquire an abnormal image, it is not possible to anticipate the performance of the reconstruction model.

### SUMMARY OF THE INVENTION

The present invention is directed to providing a method and system for localizing an anomaly in a target image, the method and system capable of training a reconstruction model on the basis of only a normal image to effectively detect an anomaly and localizing an anomaly included in a target image through the trained reconstruction model, and a method of training a reconstruction model thereof.

However, objects to be achieved by the present invention are not limited to the above-mentioned object, and other objects may be present.

According to a first aspect of the present invention, there is provided a method of localizing an anomaly in a target image, the method including training a reconstruction model using a normal image, deriving a reconstructed image by applying a target image, which is subject to detection, to the trained reconstruction model, generating an anomaly map on the basis of a result of comparing the reconstructed image and the target image, and localizing an anomaly through the generated anomaly map.

According to a second aspect of the present invention, there is provided a method of training a reconstruction model for localizing an anomaly of a target image, the method including extracting a training-related normal image and a verification-related normal image, which are distinguished according to a predetermined ratio, from a normal image, training reconstruction models suitable for corresponding numbers of segments considered according to a predetermined condition on the basis of the training-related normal image, selecting one of the trained reconstruction models suitable for the corresponding numbers of segments on the basis of the verification-related normal image, and applying the selected reconstruction model as the reconstruction model for detecting the anomaly of the target image.

According to a third aspect of the present invention, there is provided a system for localizing an anomaly in a target image, the system including a memory configured to store a program for training a reconstruction model on the basis of a normal image, generating an anomaly map from the target image on the basis of the trained reconstruction model, and localizing an anomaly and a processor configured to execute the program stored in the memory, wherein when the program is executed, the processor trains the reconstruction model using the normal image, derives a reconstructed image by applying a target image, which is subject to detection, to the trained reconstruction model, generates an anomaly map on the basis of a result of comparing the reconstructed image and the target image, and detects an anomaly through the generated anomaly map.

A computer program according to another aspect of the present invention is combined with a computer, which is hardware, to execute the method of localizing an anomaly in a target image and a method of training a reconstruction model thereof, and is stored in a computer-readable recording medium.

Other specific details of the present invention are included in the detailed description and drawings.

### BRIEF DESCRIPTION OF THE DRAWINGS

FIG. 1 is a flowchart of a method of localizing an anomaly in a target image according to an embodiment of the present invention.

FIG. 2 is a conceptual view illustrating a method of localizing an anomaly in a target image according to an embodiment of the present invention.

FIG. 3 is a diagram illustrating a process of determining the number of segments.

FIG. 4 is a diagram illustrating a process of training a reconstruction model on the basis of a training-related normal image.

FIG. 5 is a diagram showing an example of training a segmentation model.

FIG. 6 is a diagram showing an example of performing composition on a virtual anomaly.

FIG. 7 is a diagram illustrating an example of image segmentation, reconstruction, and combination.

FIG. 8 is a diagram showing an example to describe a process of calculating a reconstruction performance index.

FIG. 9 is a diagram showing another example to describe a process of calculating a reconstruction performance index.

FIG. 10 is a diagram illustrating an embodiment including multiple data categories.

FIG. 11 is a diagram illustrating an example of generating an anomaly map.

FIG. 12 is a diagram illustrating another example of generating an anomaly map.

FIG. 13 is a block diagram showing a system for localizing an anomaly in a target image.

### DETAILED DESCRIPTION OF EXEMPLARY EMBODIMENTS

Advantages and features of the present invention and implementation methods thereof will be clarified through the following embodiments described in detail with reference to the accompanying drawings. However, the present invention is not limited to embodiments disclosed herein and may be implemented in various different forms. The embodiments are provided for making the disclosure of the present invention thorough and for fully conveying the scope of the present invention to those skilled in the art. It is to be noted that the scope of the present invention is defined by the claims.

The terminology used herein is for the purpose of describing particular embodiments only and is not intended to be limiting of the invention. As used herein, the singular forms “a,” “an,” and “one” include the plural unless the context clearly indicates otherwise. The terms “comprises” and/or “comprising” used herein specify the presence of stated elements, but do not preclude the presence or addition of one or more other elements. Like reference numerals refer to like elements throughout the specification, and the term “and/or” includes any and all combinations of one or more of the associated listed items. It will also be understood that, although the terms first, second, etc. may be used herein to describe various elements, these elements should not be limited by these terms. These terms are only used to distinguish one element from another. Thus, a first element could be termed a second element without departing from the technical spirit of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

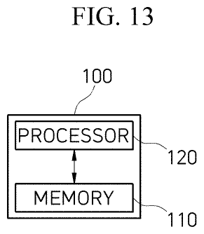

The present invention relates to a method and system 100 in FIG. 13 for localizing an anomaly in a target image and a method of training a reconstruction model thereof.

The present invention focuses on the anomaly localization in an image determined as having a problem through anomaly detection.

Most images that are available when training a model to be used to detect an anomaly are limited to normal images. This is because while it is easy to obtain a normal image, it is difficult to obtain an abnormal image, which is a target for diagnosis and detection, in advance not only in terms of technology but also in terms of cost. Also, it is not possible to determine all possible abnormal cases and pre-obtain corresponding abnormal images.

For this reason, an anomaly localization model in most conventional methods is trained based on only normal images.

In a situation where only normal images are available, an abnormal state that is subject to anomaly localization indicates that characteristics not observed in the normal images are included. Therefore, it is required to construct and train a model to extract the features of a given normal image well.

Meanwhile, one general method that is widely used to detect an anomaly on the basis of a normal image is to use a reconstruction model such as an autoencoder or a generative adversarial network (GAN).

The use of such a reconstruction model is for a reconstruction model trained based on a normal image to perform reconstruction by converting an abnormal pattern included in a target image into a normal pattern. Accordingly, a reconstructed image may be generated by applying an image that is subject to anomaly localization to the reconstruction model, and the anomaly localization may be performed by comparing the reconstructed image and the original image. For example, it can be considered that an abnormal pattern is present in a position where a difference in pixel value between a target image and a reconstructed image is significant.

The performance of anomaly localization based on such a reconstruction model is closely associated with the performance of the reconstruction model. However, most conventional techniques take advantage of the general reconstruction capability of a well-known reconstruction model rather than suggesting a method of improving or utilizing the reconstruction model in consideration of the close association. In this case, the performance of anomaly localization is limited by the performance of the reconstruction model.

Although some conventional techniques have proposed methods for effective anomaly localization, the techniques may require a training-related abnormal image that is difficult to obtain in advance or may cause a large overhead due to many models, operations, and the like. Also, these conventional techniques have a limited range of applications due to the corresponding methods.

In contrast, according to an embodiment of the present invention, a reconstruction model may be trained based on only a normal image in order to effectively detect an anomaly and may detect an anomaly included in a target image through the trained reconstruction model. In particular, there is proposed a method of improving and utilizing the performance of anomaly localization in exchange for a negligible overhead in an image space (not latent space of a model) as well as utilizing a well-known reconstruction model.

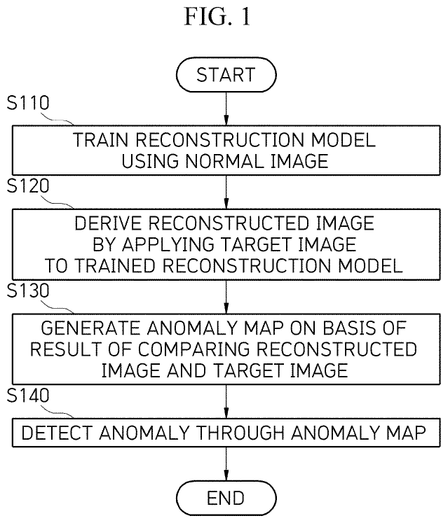

A method of localizing an anomaly in a target image according to an embodiment of the present invention will be described below with reference to FIGS. 1 to 12.

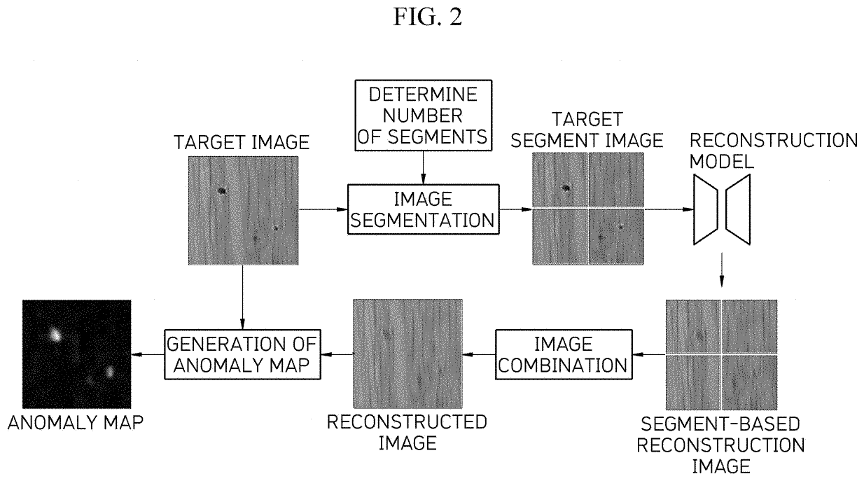

FIG. 1 is a flowchart of a method of localizing an anomaly in a target image according to an embodiment of the present invention. FIG. 2 is a conceptual view illustrating a method of localizing an anomaly in a target image according to an embodiment of the present invention.

Meanwhile, it may be understood that operations illustrated in FIG. 1 are performed by a server included in a system 100 for localizing an anomaly in a target image (hereinafter referred to as a server), but the present invention is not limited thereto.

The method of localizing an anomaly in a target image according to an embodiment of the present invention includes training a reconstruction model using a normal image (S110), applying a target image, which is subject to detection, to the trained reconstruction model to derive a reconstructed image (S120), generating an anomaly map on the basis of a result of comparing the reconstructed image and the target image (S130), and localizing an anomaly through the generated anomaly map (S140).

In this case, an embodiment of the present invention considers a situation in which only a normal image can be used to train the reconstruction model.

According to an embodiment of the present invention, by comparing a target image to a reconstructed image derived by applying the target image to a reconstruction model trained based on normal images, such as an autoencoder, an anomaly map is generated to detect anomalies.

Also, according to an embodiment of the present invention, by dividing a normal image or a target image into segments, reconstructing the segments through a reconstruction model, and combining the reconstructed segments to generate one reconstructed image, it is possible to improve the reconstruction performance of the reconstruction model and the performance of anomaly localization.

In addition, when a data category that is subject to anomaly localization (e.g., for checking whether a carpet is damaged) is determined and a corresponding normal image is given, it is necessary to determine the number of segments into which it is appropriate to divide the image of the target category so as to apply image segmentation- and reconstruction model-based anomaly localization.

To this end, according to an embodiment of the present invention, when a normal image of a data category that is subject to anomaly localization is given, there is provided a method of determining the number of segments into which the image of the corresponding category is to be divided and localizing an anomaly through image segmentation and a reconstruction model on the basis of the determined number of segments.

1. Operation of Determining Number of Segments for Image Segmentation.

First, a server trains a reconstruction model using a normal image (S110).

When normal data of a target data category is given, this operation may include determining how many segments an image is divided into for the corresponding category in order to perform image segmentation- and reconstruction model-based anomaly localization.

When the number of segments corresponding to the target data category is determined as described above, a target image belonging to the corresponding category is divided into the number of segments when a technique for image segmentation- and reconstruction model-based anomaly localization is utilized.

Meanwhile, according to an embodiment of the present invention, the data category refers to a set of normal data with similar characteristics. For example, the category is an image related to the fabrication of a specific product (e.g., a toothbrush, a transistor, etc.) which is subject to anomaly localization or a video of a specific zone (e.g., an underground communal area, an underground parking lot, etc.) which is subject to anomaly localization.

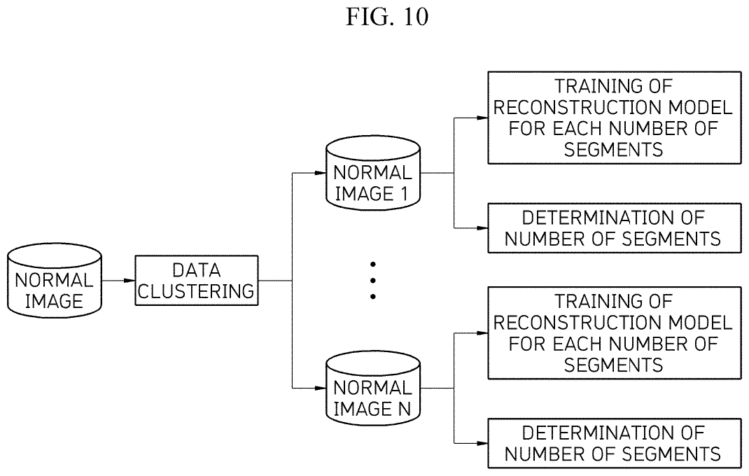

According to an embodiment of the present invention, one or more data categories may be included in a normal image or a target image, and for convenience of description, the following description assumes that each image is composed of one data category. Also, a case in which each image is composed of a plurality of data categories will be described below with reference to FIG. 10.

1.1 Operation of Training Reconstruction Model for Each Number of Segments

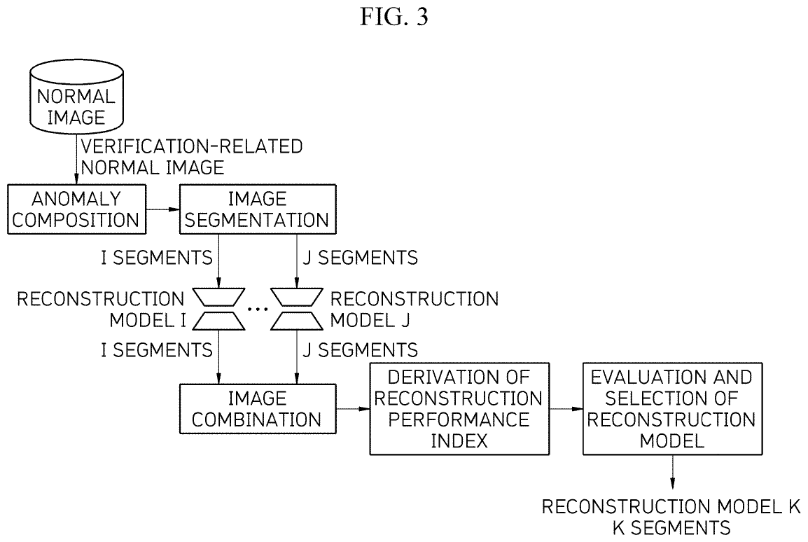

FIG. 3 is a diagram illustrating a process of determining the number of segments.

In an embodiment, the server extracts a training-related normal image and a verification-related normal image, which are distinguished according to a predetermined ratio, from the normal image.

In this case, the verification-related normal image, which is a portion of the normal image, may be data that is not used to train candidate models to be verified. For example, the verification-related normal image may be data corresponding to 20% of the normal image.

The verification-related normal image, which is a portion of the normal data, may be data that is entirely or partially used for the training.

When the training-related normal image and the verification-related normal image are determined, the server trains reconstruction models suitable for corresponding numbers of segments considered according to a predetermined condition on the basis of the training-related normal image.

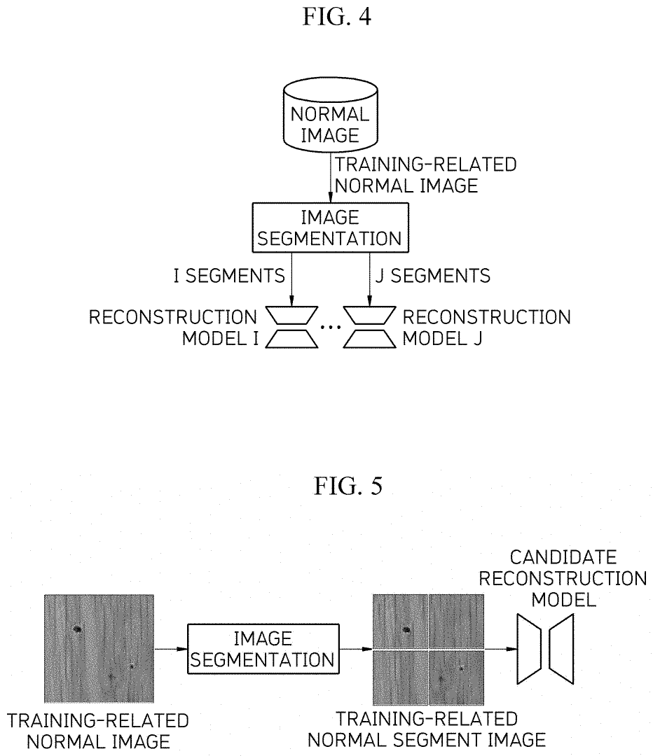

FIG. 4 is a diagram illustrating a process of training a reconstruction model on the basis of a training-related normal image. FIG. 5 is a diagram showing an example of training a segmentation model.

The first operation for determining the number of segments is to train reconstruction models suitable for the corresponding numbers of segments considered when the number of segments is determined.

In order to train a reconstruction model, a training-related normal image may be extracted from a given normal image and used. For example, data corresponding to 80% of the given normal image may be used as the training-related normal image to train the reconstruction model.

The server performs division on the same training-related normal image suitably for the corresponding numbers of segments considered according to a predetermined condition to generate training-related normal segment images.

For example, when the number of segments to be considered is 4, 9, and 16, one training-related normal image is divided into four segments, nine segments, and sixteen segments.

In this case, a list of the numbers of segments that can be considered according to a predetermined condition may be determined based on various methods.

As an example, the number of segments expected to exhibit desirable reconstruction performance through a simple initial experiment such as a pilot experiment may be determined. As another example, the number of segments may be determined according to the size of an image to be processed.

Subsequently, the server trains reconstruction models (hereinafter referred to as candidate reconstruction models) to correspond to the numbers of segments of the training-related normal segment image.

Here, the models trained according to the numbers of segments may have the same structure. Alternatively, the models trained according to the numbers of segments may have the same input image size and the same output image size. Alternatively, the models trained according to the numbers of segments may have different structures or different input image sizes and output image sizes depending on the number and size of applied segments.

FIG. 5 shows an example of training a segmentation model on the basis of a training-related normal segment image and shows that a training-related normal image is divided into four segments.

The training-related normal image extracted from the given normal image may be divided into a corresponding number of segments, and the training-related normal segment images may be used to train one candidate reconstruction model.

For example, an autoencoder-based reconstruction model may be trained to receive a training-related normal segment image and perform reconstructions to obtain segment-based reconstructed images.

Through this process, according to an embodiment of the present invention, reconstruction models are trained according to the numbers of segments to be considered based on a normal image of a target data category.

1.2 Operation of Performing Composition on Virtual Anomaly

When the training of the candidate reconstruction model is completed based on the training-related normal image, the server selects one candidate reconstruction model from among candidate reconstruction models that are trained based on the verification-related normal image and that are suitable for the corresponding numbers of segments, and applies the selected candidate reconstruction model.

In this process, according to an embodiment of the present invention, the server selects and applies a candidate reconstruction model with the highest performance by comparing reconstruction performances of a plurality of candidate reconstruction models.

In order to evaluate a reconstruction model to determine the number of segments, first, the server generates a composite image obtained by combining a virtual anomaly with the verification-related normal image.

The reason for performing composition on the anomaly and evaluating the reconstruction model based on the anomaly is to check how well the reconstruction model reconstructs an arbitrarily added anomaly into a normal pattern.

This is because in order to successfully implement a method of localizing an anomaly by comparing an input image and a reconstructed image according to the present invention, it is important to convert and reconstruct the anomaly included in the input image into a normal pattern.

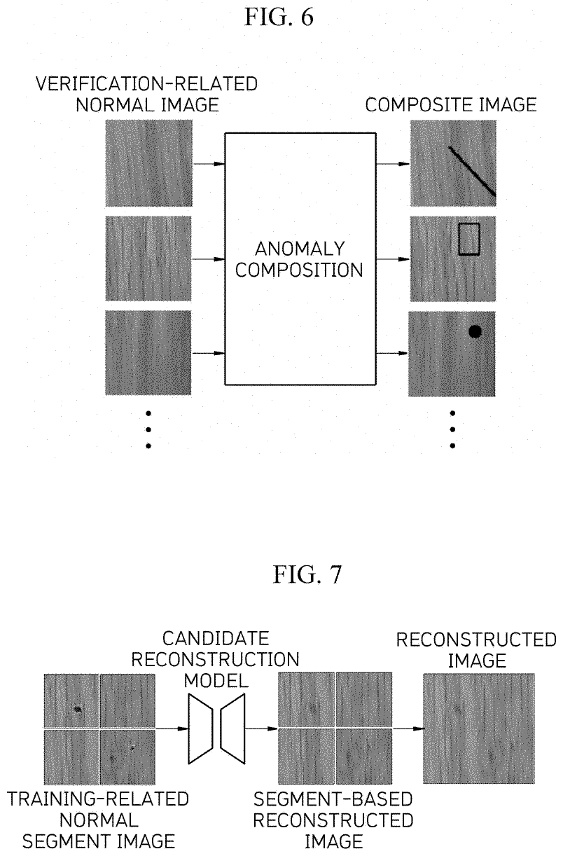

FIG. 6 is a diagram showing an example of performing composition on a virtual anomaly.

In an embodiment, a virtual anomaly may be combined with a verification-related normal image at various positions. For example, a virtual anomaly may be combined with a verification-related normal image at any position or at a position where an anomaly to be detected is expected to occur, or the composition position may be determined based on the characteristics of the verification-related normal image.

According to an embodiment, a virtual anomaly may be formed in any shape such as a line, a circle, a rectangle, and an ellipse and in the form of an anomaly to be desired or expected to be detected in a target data category.

In an embodiment, a virtual anomaly may be formed in various colors such as black and white, may be formed in a single color or in a combination of multiple colors, and may be formed with a certain degree of transparency.

In an embodiment, a virtual anomaly may be generated by modifying a part of the verification-related normal image. For example, after extracting the part of the verification-related normal image, the server may generate a virtual anomaly to be combined by applying various image processing techniques such as flip, mirror, invert, grayscale, and autocontrast.

In an embodiment, the server may combine at least one anomaly with n verification-related normal images to generate at least n composite images.

That is, the server may generate one composite image or multiple composite images from one verification-related normal image. Also, the server may combine one anomaly with one verification-related normal image or combine a plurality of anomalies with one verification-related normal image to generate a composite image.

In an embodiment, a virtual anomaly to be added to one verification-related normal image may be arbitrarily determined from among applicable anomaly forms, or the applicable anomaly forms may be determined sequentially or according to a certain rule.

1.3 Operation for Image Segmentation, Reconstruction, and Combination

FIG. 7 is a diagram illustrating an example of image segmentation, reconstruction, and combination.

Subsequently, the server derives a reconstructed image by applying a composite image obtained by performing composition on a virtual anomaly to a candidate reconstruction model.

To this end, the server divides the composite image into a number of segments suitable for each case and derives segment-based reconstructed images of the divided composite image on the basis of a candidate reconstruction model corresponding to the number of segments suitable for each case. Also, the server combines the segment-based reconstructed images to derive a reconstructed image.

Accordingly, the reconstructed image is generated by combining segment-based reconstructed images equal in number to the segments considered for one composite image.

FIG. 7 shows an example of dividing one composite image into four segments, performing reconstruction on a segment basis, and then generating one composite image. In this case, the reconstruction model shown in FIG. 7 is a candidate reconstruction model that is trained to process four segments.

1.4 Operation of Deriving Construction Performance Index

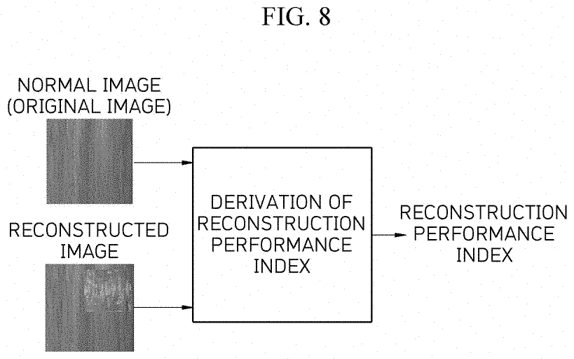

FIG. 8 is a diagram illustrating an example of calculating a reconstruction performance index.

Subsequently, the server calculates a reconstruction performance index of a candidate reconstruction model on the basis of the derived reconstructed image.

According to an embodiment of the present invention, the server calculates the reconstruction performance index of each candidate reconstruction model on the basis of a reconstructed image derived from a trained candidate reconstruction model corresponding to each number of segments to be considered.

Here, the reconstruction performance index refers to an index representing how well the anomaly added during the virtual anomaly composition process described with reference to FIG. 6 is changed to a normal pattern.

A basic method for deriving the reconstruction performance index is to compare an original image before the composition of an anomaly to a reconstructed image derived by each candidate reconstruction model.

For example, a reconstruction performance index between one original image and one reconstructed image as shown in FIG. 8 may be calculated by comparing the entire area of the original image to the entire area of the reconstructed image.

The reconstruction performance index shows how well each candidate reconstruction model changes an anomaly included in a composite image to a normal pattern and thus may be derived as a value indicating how similar the original image and the reconstructed image are or vice versa.

To this end, the reconstruction performance index may be calculated based on various criteria. As an example, the server may calculate a mean squared error (MSE)-based or structural similarity index (SSIM)-based reconstruction performance index between a verification-related normal image and a reconstructed image.

For example, an MSE reconstruction performance index between a reconstructed image R and an original image O with a size of m×n may be calculated using Equation 1 below. In this case, as the MSE reconstruction performance index increases, the difference between two images increases.

MSE Reconstruction Performance Index=1/mnΣᵢ₌₀^{m-1}Σⱼ₌₀ⁿ⁻¹[0(i,j)−R(i,j)]² [Equation 1]

As another example, the server may calculate an SSIM-based reconstruction performance index. SSIM derives SSIM values for two given images in units of a patch of a certain size and calculates one final value on the basis of the derived values. Accordingly, when an SSIM reconstruction performance index between a reconstructed image R and an original image O with a size of m×n is derived, the SSIM reconstruction performance index computed based on a k×k window may be calculated using Equation 2 below. In this case, as the SSIM reconstruction performance index increases, the similarity between two images increases.

$$SSIM Reconstruction Performance Index = \frac{( 2 {μ}_{x} {μ}_{y} + c 1 ) ( 2 {σ}_{xy} + c 2 )}{( {μ}_{{x}^{2} +} {μ}_{{y}^{2}} + c 1 ) ( {σ}_{{x}^{2} +} {σ}_{{y}^{2}} + c 2 )} \qquad [ Equation 2 ]$$

In this case, in the above Equation 2, μₓ and μ_{y} represent the mean intensity of k×k image patches of an original image and a reconstructed image, respectively, σₓ and σ_{y} represent the variances of the image patches, and σ_{xy} represents the covariance between the image patches. c1 and c2 are constants.

Through this method, reconstruction performance indices may be calculated for all the composite images.

A final reconstruction performance index of a candidate reconstruction model corresponding to a specific number of segments may be derived based on a reconstruction performance index for a composite image. As an example, a value obtained by adding and then averaging the reconstruction performance indices of the composite images may be provided as the final reconstruction performance index.

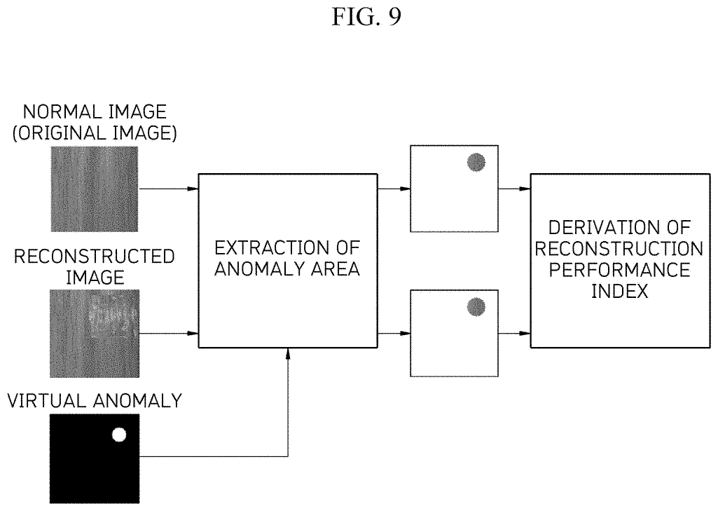

FIG. 9 is a diagram showing another example to describe a process of calculating a reconstruction performance index.

As another example, according to an embodiment of the present invention, a reconstruction performance index may be calculated by performing extraction and comparison on an area corresponding to a combined anomaly.

To this end, the server may extract an area to be used to calculate a reconstruction performance index by using an original image, a reconstructed image, and an image of the combined anomaly as inputs and may calculate the reconstruction performance index on the basis of the extracted area. As an example, the image of the combined anomaly is shown in a white color in FIG. 9.

In this case, a part extracted to calculate the reconstruction performance index may be an area of the combined anomaly or an area of a portion of the combined anomaly. Alternatively, the part extracted to calculate the reconstruction performance index may be an area greater than the area of the combined anomaly.

The calculation of the reconstruction performance index in the extracted area may be performed based on various criteria. For example, as described above, the reconstruction performance index may be derived based on MSE or may be calculated based on SSIM.

As described above, according to an embodiment of the present invention, reconstruction performance indices for all the composite images may be derived through the method described with reference to FIG. 8 or FIG. 9. Also, a final reconstruction performance index of a candidate reconstruction model corresponding to a specific number of segments may be derived based on a reconstruction performance index for a composite image. As an example, a value obtained by adding and then averaging the reconstruction performance indices of the composite images may be provided as the final reconstruction performance index.

1.5 Operation of Determining Number of Segments

Subsequently, the server selects one reconstruction model from among a plurality of candidate reconstruction models on the basis of a calculated reconstruction performance index and applies the selected reconstruction model. In this process, based on a reconstruction performance index of a candidate reconstruction model corresponding to each number of segments derived through the above-described process, the server determines the number of segments.

According to an embodiment, among a plurality of candidate reconstruction models corresponding to the numbers of segments to be considered, the number of segments corresponding to a candidate reconstruction model with the most desirable reconstruction performance index is the number of segments to be applied to a target data category.

For example, as an MSE-based reconstruction performance index decreases, the reconstruction performance increases. Thus, the server may select a candidate reconstruction model with the smallest reconstruction performance index and a corresponding number of segments.

Alternatively, as an SSIM-based reconstruction performance index increases, the reconstruction performance increases. Thus, the server may select a candidate reconstruction model with the largest reconstruction performance index and a corresponding number of segments.

Through this process, a candidate reconstruction model and the number of segments selected for a target data category are applied to a reconstruction model for performing anomaly localization on a target image belonging to the target data category.

Meanwhile, operations 1.1 to 1.5 described above may be repeatedly executed multiple times to derive several reconstruction performance indices for each number of segments, and the number of segments may be determined based on the reconstruction performance indices. For example, the number of segments and the reconstruction model may be determined by averaging the reconstruction performance indices derived by repeatedly performing the above operations. When each operation is repeatedly performed, a training-related normal image and a verification-related image which vary depending on the operation may be used.

1.6 Case in which Multiple Data Categories are Included

FIG. 10 is a diagram illustrating an embodiment including multiple data categories.

In the above-described embodiment of the present invention, the following description assumes that one data category is included in a normal image or a target image, but the present invention is not limited thereto. The image may be composed of a plurality of data categories.

When several normal images, each of which includes only one data category, are given, an appropriate number of segments may be determined for each normal image by applying the above-described procedure to the normal images.

At this time, one situation to be considered is a case in which multiple categories are included in one normal image because there is no data category label. Even in this case, the above-described method may be applied as it is. However, according to an embodiment of the present invention, for better performance, a normal image may be segmented into a plurality of data clusters on the basis of characteristic information of the normal image, and a reconstruction model may be trained based on the data clusters obtained through the segmentation.

That is, when a plurality of categories are included, a normal image may be segmented into data clusters exhibiting similar characteristics, and the above-described method may be applied to the clusters.

In this case, the applied data clustering technique may be selected based on the characteristics of the given normal image. Also, the number of derived data clusters may be designated according to a specific criterion or may be autonomously determined according to the applied data clustering technique.

By applying the above-described method to the derived data clusters according to the data clustering technique, the number of segments and an appropriate reconstruction model may be determined for each of the derived data clusters.

Also, when anomaly localization is performed in a given target image, a data clustering technique trained when a normal image is divided into data clusters may be applied. Thus, a data cluster to which the target image belongs may be determined, and anomaly localization may be performed on the basis of the number of segments derived from the corresponding data cluster.

1.7 Validation

A validation experiment of the method of determining the number of segments according to an embodiment of the present invention was conducted on a given data category.

The determination of the number of segments proposed in the present invention is to determine the number of segments into which a target data category should be divided in order to exhibit better anomaly localization performance.

Accordingly, according to an embodiment of the present invention, the validation should be able to determine the number of segments which exhibits the best anomaly localization performance among a plurality of possible numbers of segments.

To this end, the experiment was conducted in the following environment.
A convolutional autoencoder was used as a reconstruction model.
A MVTec anomaly localization dataset (MVTecAD) was used as experimental data.
The MVTecAD is disclosed in the paper “Paul Bergmann, Michael Fauser, David Sattlegger, and Carsten Steger. MVTeC AD—A Comprehensive Real-World Dataset for Unsupervised Anomaly localization. CVPR, 2019,” and is widely used as data for verifying the performance of an anomaly localization model.
The MVTecAD is composed of 15 data categories, and the number of segments of each data category was determined in this experiment.
The MVTecAD includes normal images and various target images that may be used to verify the performance of the reconstruction model for anomaly localization.
For each data category, 80% of the given normal image was used as a training-related normal image for training the reconstruction model, and the remaining 20% was used as a verification-related normal image for determining the number of segments through the verification of the reconstruction model.
Also, in relation to the composition of a virtual anomaly, one composite image was generated for each verification-related normal image. In this case, combined anomalies were linear, circular, and quadrangular and were sequentially applied.
An MSE-based reconstruction performance index was used as a reconstruction performance index and was applied to only the areas of the combined anomalies.
Also, the numbers of segments being considered are 4, 9, and 16.

In the above-described experimental conditions, in order to validate the method of determining the number of segments according to the present invention, an MSE reconstruction performance index of a reconstruction model corresponding to each number of segments was calculated, and a correlation with anomaly localization performance based on a target image included in the MVTecAD was computed.

A large correlation between the reconstruction performance index and the detection performance indicates that the number of segments determined based on a reconstruction performance index derived using only a normal image exhibits good results even in actual anomaly localization.

Receiver Operating Characteristic-Area Under the Curve (ROC-AUC) was used as an anomaly localization performance value.

Tables 1 to 3 show results derived in the above-described experimental environment.

TABLE 1
MSE Reconstruction Performance Index

| | 4 segments | 9 segments | 16 segments |
|---|---|---|---|
| carpet | 2544 | 2224 | 3191 |
| grid | 2122 | 4545 | 5510 |
| leather | 83 | 103 | 96 |
| tile | 4796 | 5403 | 7236 |
| wood | 1079 | 4094 | 857 |
| bottle | 7297 | 8687 | 9350 |
| cable | 9594 | 10488 | 10638 |
| capsule | 12049 | 14733 | 16170 |
| hazelnut | 1276 | 1373 | 1657 |
| metal_nut | 2452 | 3058 | 3182 |
| pill | 9559 | 11644 | 12678 |
| screw | 21080 | 18711 | 18307 |
| toothbruth | 1078 | 1378 | 2477 |
| transistor | 3464 | 4184 | 4765 |
| zipper | 5219 | 4940 | 5443 |

TABLE 2
1-AUC

| | 4 segments | 9 segments | 16 segments |
|---|---|---|---|
| carpet | 0.04704 | 0.05736 | 0.11545 |
| grid | 0.02475 | 0.02292 | 0.04003 |
| leather | 0.01419 | 0.01074 | 0.00466 |
| tile | 0.05874 | 0.09617 | 0.10819 |
| wood | 0.03189 | 0.02916 | 0.02706 |
| bottle | 0.01438 | 0.01374 | 0.01588 |
| cable | 0.05482 | 0.09603 | 0.16922 |
| capsule | 0.04054 | 0.04239 | 0.06076 |
| hazelnut | 0.0059 | 0.01536 | 0.02923 |
| metal_nut | 0.02439 | 0.04745 | 0.12296 |
| pill | 0.01488 | 0.03875 | 0.05643 |
| screw | 0.00756 | 0.02558 | 0.05447 |
| toothbruth | 0.01284 | 0.00787 | 0.01517 |
| transistor | 0.05238 | 0.15839 | 0.30401 |
| zipper | 0.01265 | 0.01178 | 0.01596 |

TABLE 3
Pearson Correlation

| | CORREL |
|---|---|
| carpet | 0.891 |
| grid | 0.649 |
| leather | −0.512 |
| tile | 0.841 |
| wood | −0.014 |
| bottle | 0.523 |
| cable | 0.852 |
| capsule | 0.818 |
| hazelnut | 0.986 |
| metal_nut | 0.789 |
| pill | 0.994 |
| screw | −0.867 |
| toothbruth | 0.594 |
| transistor | 0.988 |
| zipper | 0.926 |

In this case, the MSE reconstruction performance index in Table 1 is a reconstruction performance index for a composite image generated from a verification-related normal image and is the average of all composite images. 1-AUC in Table 2 is a value obtained by modifying an AUC value derived from a target image in order to derive a correlation. A Pearson correlation value of Table 3 represents the Pearson correlation coefficient between the reconstruction performance index and 1-AUC value.

As shown in each table, it can be seen that there is a high correlation in most categories except for some categories such as leather, wood, and screw. This means that the method of determining the number of segments of the target data category based on the normal image, which is proposed by the present invention, is valid.

2. Operation for Image Segmentation-Based Anomaly Localization

2.1 Operation of Detecting Anomaly

Referring to FIGS. 1 and 2 again, as described above, when a number of segments and a reconstruction model appropriate for a specific data category are determined through a reconstruction model training process based on a normal image, the server performs a process of localizing an anomaly of a target image belonging to the corresponding data category.

In this process, according to an embodiment of the present invention, anomaly localization may not be applied to all given target images. That is, a target image, which is potentially subject to detection, undergoes a separate anomaly detection procedure. The anomaly localization proposed by the present invention may be performed only when it is determined that there is an anomaly in this process.

Alternatively, anomaly localization may be performed on all given target images.

The server derives a reconstructed image by applying a target image, which is subject to detection, to the trained reconstruction model (S120).

In this operation, the target image is divided into a number of segments equal to the number of segments determined for a data category to which the corresponding image belongs. That is, the server divides a target image into a number of segments equal to the number of segments for the applied reconstruction model to generate target segment images. In an example of FIG. 2, it is shown that a target image is divided into four target segment images.

Subsequently, the server applies the target segment images to a selected reconstruction model to derive segment-based reconstruction images and combines the segment-based reconstructed images to derive one reconstructed image with the same resolution as the input target image.

Then, the server generates an anomaly map on the basis of a result of comparing the reconstructed image and the target image (S130) and detects an anomaly through the generated anomaly map (S140).

In an embodiment of the present invention, the comparison between the input image and the reconstructed image to generate the anomaly map may be performed in various ways.

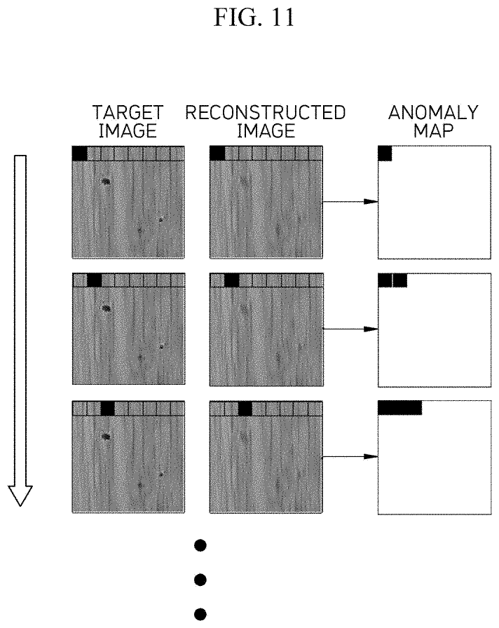

FIG. 11 is a diagram illustrating an example of generating an anomaly map.

In an embodiment, the server may generate an anomaly map by comparing a target image and a reconstructed image on a pixel basis.

That is, the server may divide the target image and the reconstructed image on a pixel basis and may generate an anomaly map on the basis of a pixel value difference obtained by comparing identical pixels of the target image and the reconstructed image divided on a pixel basis.

FIG. 11 shows an example of comparing a target image and a reconstructed image on a pixel basis. A small quadrangle in each image refers to one pixel, and black pixels in the target image and the reconstructed image refer to pixels which are subject to computation.

For example, an anomaly map M may be generated based on a pixel value difference between a reconstructed image R and an input image O with a size of m×n and may be expressed using Equation 3 below.

M(i,j)=abs(0(i,j)−R(i,j)),1≤i≤m,1≤j≤m [Equation 3]

In Equation 3, as the pixel value of the anomaly map increases, the corresponding pixel becomes close to an abnormal state.

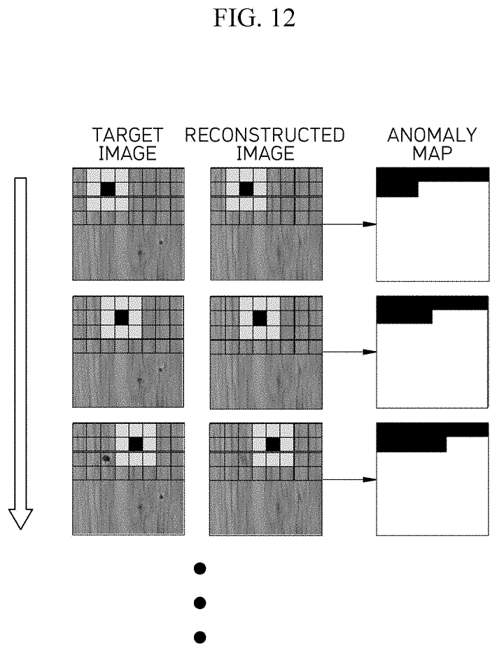

FIG. 12 is a diagram illustrating another example of generating an anomaly map.

In another embodiment, the server may apply a window of a predetermined size centered on identical pixels of a target image and a reconstructed image divided on a pixel basis and may generate an anomaly map on the basis of a pixel value difference in a pixel-centered window.

That is, according to an embodiment of the present invention, a value is generated for each pixel. In this case, an anomaly map may be generated even in consideration of pixels surrounding a target pixel.

FIG. 12 shows an example of applying a pixel-centered window to generate an anomaly. A small quadrangle in each image refers to one pixel, black pixels in the target image and the reconstructed image refer to pixels which are subject to computation, and gray pixels near the black pixels refer to nearby pixels which are considered together with the black pixels.

For example, an anomaly map M may be calculated by applying a k×k window centered on target pixels of a reconstructed image R and an input image O with a size of m×n, and a target pixel-centered window-based MSE value may be expressed using Equation 4 below.

M(i,j)=1/kkΣₗ₌ᵢ₋ₖ^{i+k/2}Σ_{k=j-k/2}^{j+k/2}[0(l,k)−R(l,k)]²1≤i≤m,1≤j≤m [Equation 4]

In Equation 4, as the pixel value of the anomaly map increases, the corresponding pixel becomes close to an abnormal state.

As another example, an anomaly map M may be calculated by applying a k×k window centered on target pixels of a reconstructed image R and an input image O with a size of m×n, and a target pixel-centered window-based SSIM value may be expressed using Equation 5 below.

$$M ( i , j ) = 1 - \frac{( 2 {μ}_{x} {μ}_{y} + c 1 ) ( 2 {σ}_{xy} + c 2 )}{( {μ}_{{x}^{2} +} {μ}_{{y}^{2}} + c 1 ) ( {σ}_{{x}^{2} +} {σ}_{{y}^{2}} + c 2 )} , 1 \leq i \leq m , 1 \leq j \leq m \qquad [ Equation 5 ]$$

In the above Equation, μₓ and μ_{y} represent the mean intensity of k×k image patches of an original image and a reconstructed image, respectively, σₓ and σ_{y} represent the variances of the image patches, and σ_{xy} represents the covariance between the image patches. c1 and c2 are constants,

In Equation 5, as the pixel value of the anomaly map increases, the corresponding pixel becomes close to an abnormal state.

The server uses the generated anomaly map as a result of anomaly localization.

Meanwhile, the generated anomaly map may be used as a result of anomaly localization after post-processing is applied. For example, the server may remove outliers spanning only a few pixels through post-processing. The server may generate a new anomaly diagnosis map by applying a threshold to the generated anomaly map and adding only a case greater than the threshold and may use the generated anomaly diagnosis map as a result of anomaly localization.

2.2 Validation

An experiment was conducted to validate the image segmentation- and reconstruction model-based anomaly localization proposed by the present invention.

The experimental environment is the same as described above.

TABLE 4

| | No segments | 4 segments | 9 segments | 16 segments |
|---|---|---|---|---|
| carpet | 0.92241 | 0.95296 | 0.94264 | 0.88455 |
| grid | 0.80036 | 0.97525 | 0.97708 | 0.95997 |
| leather | 0.84957 | 0.98581 | 0.98926 | 0.99534 |
| tile | 0.825 | 0.94126 | 0.90383 | 0.89181 |
| wood | 0.98755 | 0.96811 | 0.97084 | 0.97294 |
| bottle | 0.98291 | 0.98562 | 0.98626 | 0.98412 |
| cable | 0.99813 | 0.94518 | 0.90397 | 0.83078 |
| capsule | 0.89909 | 0.95946 | 0.95761 | 0.93924 |
| hazelnut | 0.97406 | 0.9941 | 0.98464 | 0.97077 |
| metal_nut | 0.97161 | 0.97561 | 0.95255 | 0.87704 |
| pill | 0.93873 | 0.98512 | 0.96125 | 0.94357 |
| screw | 0.96516 | 0.99244 | 0.97442 | 0.94553 |
| toothbruth | 0.83704 | 0.98716 | 0.99213 | 0.98483 |
| transistor | 0.96635 | 0.94762 | 0.84161 | 0.69599 |
| zipper | 0.98967 | 0.98735 | 0.98822 | 0.98404 |
| Average | 0.927176 | 0.972203333 | 0.955087333 | 0.924034667 |

Table 4 shows a result of comparing anomaly localization performance (AUC) when image segmentation is not applied to a convolutional autoencoder model (no segments are generated) and AUC when 4, 9, and 16 segments are applied to the convolutional autoencoder model.

As shown in the table, it can be seen that anomaly localization performance is improved when an image is divided into four and nine segments compared to when image segmentation is not applied.

TABLE 5

| | ICLR2020 | CVPR2019 | Present Invention |
|---|---|---|---|
| carpet | 0.774 | 0.880 | 0.95296 |
| grid | 0.981 | 0.940 | 0.97976 |
| leather | 0.925 | 0.970 | 0.99279 |
| tile | 0.654 | 0.930 | 0.94126 |
| wood | 0.838 | 0.910 | 0.96811 |
| bottle | 0.951 | 0.930 | 0.98562 |
| cable | 0.910 | 0.860 | 0.94522 |
| capsule | 0.952 | 0.940 | 0.96554 |
| hazelnut | 0.988 | 0.970 | 0.9941 |
| metal_nut | 0.920 | 0.890 | 0.97561 |
| pill | 0.935 | 0.910 | 0.98512 |
| screw | 0.983 | 0.960 | 0.99244 |
| toothbruth | 0.985 | 0.930 | 0.98716 |
| transistor | 0.934 | 0.900 | 0.94782 |
| zipper | 0.889 | 0.880 | 0.98964 |
| Average | 0.908 | 0.920 | 0.9735 |

Table 5 shows a result of comparing the anomaly localization performance of the method proposed by the present invention and the performance of the latest performance technique. The paper ICLR2020 (David Dehaene, Oriel Frigo, Sébastien Combrexelle, and Pierre Eline. Iterative energy-based projection on a normal data manifold for anomaly localization. ICLR, 2020) and CVPR2019 (Paul Bergmann, Michael Fauser, David Sattlegger, and Carsten Steger. MVTeC AD—A Comprehensive Real-World Dataset for Unsupervised Anomaly localization. CVPR, 2019) was presented at a world-class artificial intelligence conference and exhibits the best performance in anomaly localization at that time.

As shown in Table 5, it can be seen that the method proposed by the present invention exhibits better anomaly localization performance compared to a conventional technique that has been regarded as having the best performance. This shows the validity and excellence of the method proposed by the present invention.

In the above description, operations S110 to S140 may be divided into sub-operations or combined into a smaller number of operations depending on the implementation of the present invention. Also, if necessary, some of the operations may be omitted, or the operations may be performed in an order different from that described above. Furthermore, although not described here, the above description with reference to FIGS. 1 to 12 may apply to a system 100 for localizing an anomaly of FIG. 13.

FIG. 13 is a block diagram showing a system 100 for localizing an anomaly in a target image.

The anomaly localization system 100 according to an embodiment of the present invention includes a memory 110 and a processor 120.

A program for training a reconstruction model based on a normal image, generating an anomaly map from a target image on the basis of the trained reconstruction model, and localizing an anomaly is stored in the memory 110.

When executing the program stored in the memory 110, the processor 120 trains a reconstruction model using a normal image, applies a target image, which is subject to detection, to the trained reconstruction model to derive a reconstructed image, generates an anomaly map on the basis of a result of comparing the reconstructed image and the target image, and detects an anomaly through the generated anomaly map.

The above-described method according to an embodiment of the present invention may be implemented as a program (or application) that can be executed in combination with a computer, which is hardware, and the program may be stored in a medium.

In order for the computer to read the program and execute the method implemented with the program, the program may include code of a computer language such as C, C++, JAVA, Ruby, and machine code which can be read by a processor (central processing unit (CPU)) of the computer through a device interface of the computer. Such code may include functional code associated with a function defining functions necessary to execute the methods and the like and may include control code associated with an execution procedure necessary for the processor of the computer to execute the functions according to a predetermined procedure. Also, such code may further include memory reference-related code indicating a position (an address number) of a memory inside or outside the computer at which additional information or media required for the processor of the computer to execute the functions should be referenced. Further, in order for the processor of the computer to execute the functions, when the processor needs to communicate with any other computers or servers, etc. at a remote location, the code may further include communication-related code indicating how the processor of the computer communicates with any other computers or servers at a remote location using a communication module of the computer, what information or media the processor of the computer transmits or receives upon communication, and the like.

The storage medium refers not to a medium that temporarily stores images, such as a register, a cache, and a memory but to a medium that semi-permanently stores images and that is readable by a device. In detail, examples of the storage medium include read-only memory (ROM), random-access memory (RAM), CD-ROMs, magnetic tapes, floppy disks, optical image storage devices, etc., but the present invention is not limited thereto. That is, the program may be stored in various recording media on various servers accessible by the computer or in various recording media on a user's computer. Also, the medium can also be distributed over network-coupled computer systems so that the computer-readable code is stored in a distributed fashion.

According to an embodiment of the present invention, a reconstructed image for localizing an anomaly is generated through image segmentation and combination in an image area, and thus it is possible to easily apply to a conventionally well-known reconstruction model

Also, as can be seen from the results of validation experiments, it is possible to improve anomaly localization performance through simple processing in an image area.

In addition, through the validation results, it can be seen that the number of segments to be applied in the case of a target data category derived based on only a normal image actually has excellent test performance results.

Advantageous effects of the present invention are not limited to the aforementioned effects, and other effects which are not mentioned here can be clearly understood by those skilled in the art from the above description.

The above description of the present invention is merely illustrative, and those skilled in the art should understand that various changes in form and details may be made therein without departing from the technical spirit or essential features of the invention. Therefore, the above embodiments are to be regarded as illustrative rather than restrictive. For example, each element described as a single element may be implemented in a distributed manner, and similarly, elements described as being distributed may also be implemented in a combined manner.

The scope of the present invention is shown by the following claims rather than the foregoing detailed description, and all changes or modifications derived from the meaning and scope of the claims and their equivalents should be construed as being included in the scope of the present invention.

What is claimed is:

1. A method of localizing an anomaly in a target image wherein the method is performed by a computer, the method comprising:
training a reconstruction model using a normal image;
deriving a reconstructed image by applying a target image, which is subject to detection, to the trained reconstruction model;
generating an anomaly map on the basis of a result of comparing the reconstructed image and the target image; and
localizing an anomaly through the generated anomaly map.

2. The method of claim 1, wherein the training of the reconstruction model using the normal image comprises:
extracting a training-related normal image and a verification-related normal image, which are distinguished according to a predetermined ratio, from the normal image;
training reconstruction models suitable for corresponding numbers of segments considered according to a predetermined condition on the basis of the training-related normal image; and
selecting and applying one of the trained reconstruction models suitable for the corresponding numbers of segments on the basis of the verification-related normal image.

3. The method of claim 2, wherein the extracting of the training-related normal image and the verification-related normal image, which are distinguished according to the predetermined ratio, from the normal image comprises extracting a normal image that is not used to train the reconstruction model as the verification-related normal image.

4. The method of claim 2, wherein the training of the reconstruction models suitable for the corresponding numbers of segments considered according to the predetermined condition on the basis of the training-related normal image comprises:
generating a training-related normal segment image obtained by performing division on the same training-related normal image suitably for the corresponding numbers of segments considered according to the predetermined condition; and
training reconstruction models (hereinafter referred to as candidate reconstruction models) suitably for corresponding numbers of segments of the training-related normal segment image.

5. The method of claim 4, wherein the selecting and applying of one of the trained reconstruction models suitable for the corresponding numbers of segments on the basis of the verification-related normal image comprises:
generating a composite image obtained by combining a virtual anomaly with the verification-related normal image;
deriving a reconstructed image by applying the composite image to the candidate reconstruction models;
calculating reconstruction performance indices of the candidate reconstruction models on the basis of the reconstructed image; and
selecting and applying one of the candidate reconstruction models as the reconstruction model on the basis of the calculated reconstruction performance indices.

6. The method of claim 5, wherein the generating of the composite image obtained by combining the virtual anomaly with the verification-related normal image comprises combining at least one virtual anomaly with n verification-related normal images to generate at least n composite images.

7. The method of claim 5, wherein the deriving of the reconstructed image by applying the composite image to the candidate reconstruction models comprises:
performing division on the composite image suitably for the corresponding numbers of segments;
deriving segment-based reconstructed images of the composite image on the basis of candidate reconstruction models suitable for the corresponding numbers of segments; and
combining the segment-based reconstructed images to generate the reconstructed image.

8. The method of claim 5, wherein the calculating of the reconstruction performance indices of the candidate reconstruction models on the basis of the reconstructed image comprises calculating reconstruction performance indices based on a mean squared error (MSE) or a structural similarity index (SSIM) between the reconstructed image and the verification-related normal image.

9. The method of claim 5, wherein the deriving of the reconstructed image by applying the target image, which is subject to detection, to the trained reconstruction model comprises:
generating target segment images by performing division on the target image suitably for the number of segments of the applied reconstruction model;
deriving segment-based reconstructed images by applying the target segment images to the selected reconstruction model; and
deriving the reconstructed image by combining the segment-based reconstructed images.

10. The method of claim 9, wherein the generating of the anomaly map on the basis of the result of comparing the reconstructed image and the target image comprises:
dividing the target image and the reconstructed image on a pixel basis; and
generating the anomaly map on the basis of pixel value difference obtained by comparing identical pixels of the target image and the reconstructed image divided on a pixel basis.

11. The method of claim 10, wherein the generating of the anomaly map on the basis of the result of comparing the reconstructed image and the target image comprises: applying a window of a predetermined size centered on the identical pixels of the target image and the reconstructed image divided on a pixel basis and generating the anomaly map on the basis of a pixel value difference in the pixel-centered window.

12. The method of claim 11, wherein the generating of the anomaly map on the basis of the result of comparing the reconstructed image and the target image comprises calculating a pixel value difference based on a mean squared error (MSE) or a structural similarity index (SSIM) in the pixel-centered window.

13. The method of claim 1, wherein the training of the reconstruction model using the normal image comprises:
dividing the normal image into a plurality of data clusters on the basis of characteristic information of the normal image when a plurality of categories are included in the normal image; and
training the reconstruction model on the basis of the data clusters.

14. A method of training a reconstruction model for localizing an anomaly of a target image, the method comprising:
extracting a training-related normal image and a verification-related normal image, which are distinguished according to a predetermined ratio, from a normal image;
training reconstruction models suitable for corresponding numbers of segments considered according to a predetermined condition on the basis of the training-related normal image;
selecting one of the trained reconstruction models suitable for the corresponding numbers of segments on the basis of the verification-related normal image; and
applying the selected reconstruction model as the reconstruction model for detecting the anomaly of the target image.

15. A system for localizing an anomaly in a target image, the system comprising:
a memory configured to store a program for training a reconstruction model on the basis of a normal image, generating an anomaly map from the target image on the basis of the trained reconstruction model, and localizing an anomaly; and
a processor configured to execute the program stored in the memory,
wherein when the program is executed, the processor trains the reconstruction model using the normal image, derives a reconstructed image by applying a target image, which is subject to detection, to the trained reconstruction model, generates an anomaly map on the basis of a result of comparing the reconstructed image and the target image, and detects an anomaly through the generated anomaly map.

16. The system of claim 15, wherein the processor extracts a training-related normal image and a verification-related normal image, which are distinguished according to a predetermined ratio, from the normal image, trains reconstruction models suitable for corresponding numbers of segments considered according to a predetermined condition on the basis of the training-related normal image, and selects and applies one of the trained reconstruction models suitable for the corresponding numbers of segments on the basis of the verification-related normal image.

17. The system of claim 16, wherein the processor generates a training-related normal segment image obtained by performing division on the same training-related normal image suitably for the corresponding numbers of segments according to the predetermined condition and trains reconstruction models (hereinafter referred to as candidate reconstruction models) suitably for corresponding numbers of segments of the training-related normal segment image.

18. The system of claim 17, wherein the processor generates a composite image obtained by combining a virtual anomaly with the verification-related normal image, derives a reconstructed image by applying the composite image to the candidate reconstruction models, calculates reconstruction performance indices of the candidate reconstruction models on the basis of the reconstructed image, and selects and applies one of the candidate reconstruction models as the reconstruction model on the basis of the calculated reconstruction performance indices.

19. The system of claim 18, wherein the processor generates target segment images by performing division on the target image suitably for the number of segments of the applied reconstruction model; derives segment-based reconstructed images by applying the target segment images to the selected reconstruction model, and derives the reconstructed image by combining the segment-based reconstructed images.

20. The system of claim 19, wherein the processor divides the target image and the reconstructed image on a pixel basis and generates the anomaly map on the basis of a pixel value difference obtained by comparing identical pixels of the target image and the reconstructed image divided on a pixel basis.
